(19) United States
(12) Patent Application Publication
(10) Pub. No.: US 2024/0246160 A1
(43) Pub. Date: Jul. 25, 2024

(54) FOOD-CUTTING APPARATUS

(71) Applicant: Chia-Cheng CHI, Taichung City (TW)

(72) Inventor: Chia-Cheng CHI, Taichung City (TW)

(21) Appl. No.: 18/156,946

(22) Filed: Jan. 19, 2023

(51) Int. Cl. B23D 59/00; B23D 55/04; B23D 55/06

(52) U.S. Cl. CPC B23D 59/001; B23D 55/046; B23D 55/065; B23D 59/006; A22C 17/0033

(57) ABSTRACT

A food-cutting apparatus has a base; a trolley for placing a food object; a cutting device having two saw wheels, a power source, and a saw belt that is wound around the two saw wheels as a loop. The power source drives the two saw wheels to rotate and further drives the saw belt to circle. The trolley moves the food object so that the food object is cut by the saw belt. The saw belt has teeth oppositely at its two edges. The detector monitors intactness of the teeth and generates a warning signal when determining that any of the teeth is worn. The controlling device cuts off the power source and slows down the trolley when receiving the warning signal.

### BACKGROUND OF THE INVENTION

### 1. Field of the Invention

The present invention relates to machinery for food processing, and more particularly to a food-cutting apparatus.

### 2. Description of the Related Art

Bone-sawing machines are used in the food processing industry for cutting frozen meat and bones. A conventional food bone-sawing machine comprises a trolley, belt wheels, and saw belts. The saw belts are wound around the belt wheels so that when the belt wheels rotate, the saw belts are driven to move and cut frozen meat or bones placed on the trolley.

Since frozen meat and bones are usually very hard, the saw belt tends to get worn and become blunt over time. Once this happens, the saw belt is prevented from cutting sharply and may be pushed and depart from its original position by the counterforce from the frozen meat or bones it cuts. Such deflection of the saw belts can lead to uneven cuts on the frozen meat or bones and degrade food processing results.

However, until the saw belt is seriously damaged or even breaks, finding wear of saw belts with naked human eyes is quite difficult because the processing line usually operates at a high speed. It is thus very common that, in practice, saw belts in the early stage of wear and deflection are used to cut frozen meat or bones and undermine the quality of the processed food.

### SUMMARY OF THE INVENTION

To address the issues in the prior art, the present invention provides a food-cutting apparatus, which features an ability to effectively detect whether teeth on its saw belt have been worn and to stop or slow down its operation when detecting so, thereby enabling timely replacement of a new saw belt and ensuring good cutting performance.

In one embodiment, the present invention provides a food-cutting apparatus, which comprises: a base; a trolley, which is movably mounted on the base for a food object to place thereon; a cutting device, which is movably mounted on the base and has two saw wheels, a power source, and a saw belt, the two saw wheels being vertically separated with respect to the base, the saw belt being wound around the two saw wheels as a loop, the power source driving the two saw wheels to rotate and further driving the saw belt to circle, and the trolley driving the food object so that the food object is cut by the saw belt, wherein teeth are provided on the two opposite, lateral edges of the saw belt; a detector, which is located beside the saw belt and serves to monitor intactness of the teeth of the saw belt and generate a warning signal when determining that any of the teeth is worn; and a controlling device, which is coupled to the trolley, the power source of the cutting device, and the detector, and serves to cut off the power source and slow down movement of the trolley when receiving the warning signal generated by the detector.

In one embodiment, the present invention further has a plurality of guide blocks, arranged correspondingly beside the two saw wheels and the saw belt, so that when the two saw wheels rotate and the saw belt circles, the guide blocks remove residues of the food object from the two saw wheels and the saw belt.

In one embodiment, the present invention further has a plurality of blast guns, located correspondingly beside the saw belt and close to one of the saw wheels for spurting gas to blow off the residues of the food object from the saw belt.

With the foregoing configurations, the present invention can effectively monitor intactness of the teeth of the saw belt and timely stop or slow down movement of the trolly when determining that the saw belt is worn, so as to inform an operator to replace the saw belt. Thereby, the problem of the prior art about poor quality of food processing caused by incapability of automatically detecting wear of the saw belt can be effectively addressed.

Furthermore, with the single saw belt having teeth at its two opposite, lateral edges, the disclosed apparatus can effectively improve food processing efficiency.

In addition, with the guide blocks and the blast guns, the disclosed apparatus is capable of effectively removing food residues from the saw wheels and the saw belt, thereby keeping the apparatus clean.

### BRIEF DESCRIPTION OF THE DRAWINGS

FIG. 1 is a perspective view of a food-cutting apparatus in one embodiment of the present invention.

FIG. 2 is a schematic side view of the food-cutting apparatus.

FIG. 3 is a local, close-up view of FIG. 1.

FIG. 4 is a partial, front view of the food-cutting apparatus, showing its saw belt straight.

FIG. 5, similar to FIG. 4, but shows the saw belt now deflective.

FIG. 6 and FIG. 7 are applied views of the food-cutting apparatus, showing the saw belt cutting food.

FIG. 8 is a local, close-up view of FIG. 7, showing guide blocks and blast guns removing food residues.

FIG. 9 illustrates a part of the food-cutting apparatus according to another embodiment of the present invention, showing flanges raised from two sides of the saw wheel.

### DETAILED DESCRIPTION OF THE INVENTION

Some preferred embodiments as reflected in the accompanying drawings are described below to clearly exhibit the conception of the present invention. Instead of being depicted in scale, objects in the drawings may be exaggerated or somehow omitted for illustrative purposes.

It is also to be noted that, spatial descriptions, such as “above,” “below,” “front,” “back,” “inside,” “outside,” and “lateral” are indicated with respect to the orientation shown in the figures unless otherwise specified, and by no means form limitation to the present invention.

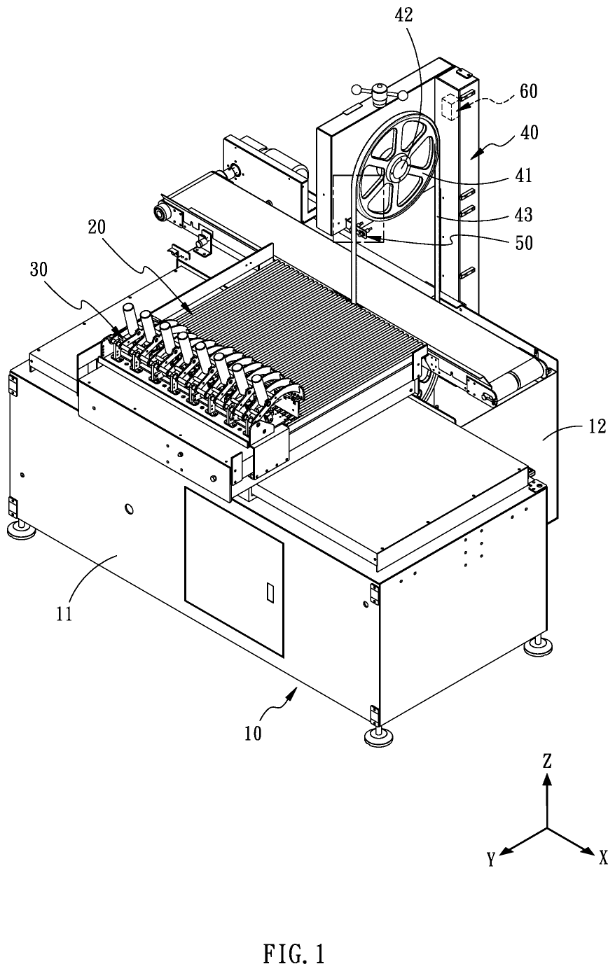

Referring to FIG. 1 through FIG. 9, the present invention provides a food-cutting apparatus, comprising a base 10, a trolley 20, a cutting device 40, a detector 50, a controlling device 60, a plurality of guide blocks 70, and a plurality of blast guns 80.

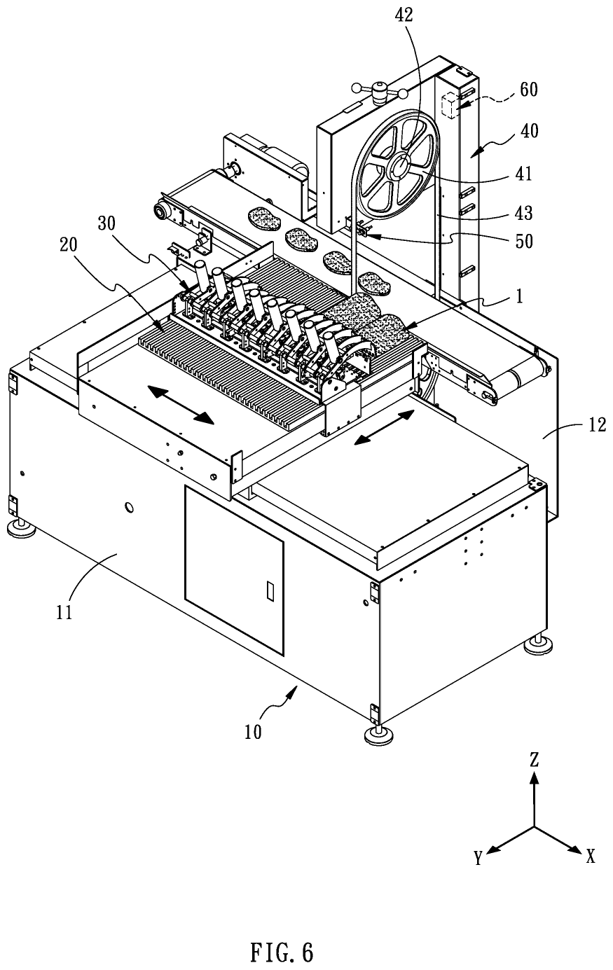

The base 10 is rectangular in shape and has a first installation area 11 and a second installation area 12, as shown in FIG. 1 and FIG. 6.

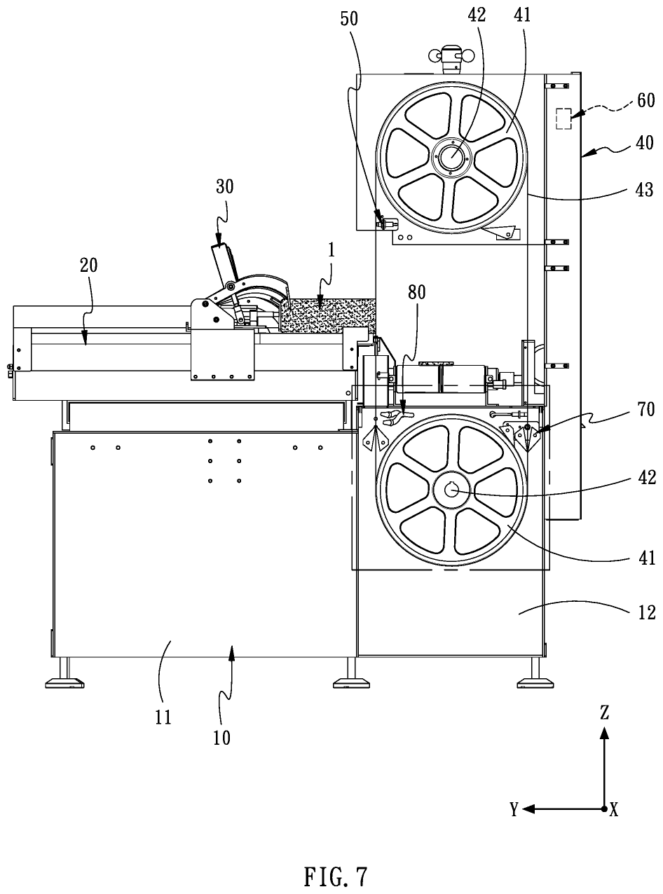

The trolley 20 is movably installed in the first installation area 11 of the base 10 and is correspondingly located in the XY plane of the base 10. The trolley 20 is for a food object 1 to place thereon. The trolley 20 is provided with a movable feeding device 30, which is configured to push the food object 1. The feeding device 30 pushes the food object 1 to move with respect to the Y axis of the base 10 while being carried by the trolley 20 to move with respect to the X axis of the base 10, as shown in FIG. 1, FIG. 6, and FIG. 7.

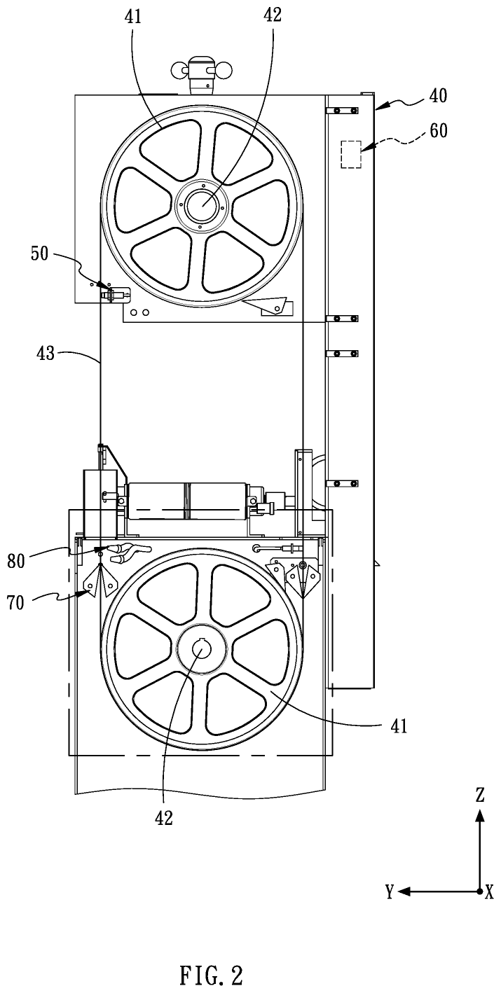

The cutting device 40 is installed in the second installation area 12 of the base 10 and has two saw wheels 41, a power source 42, and a saw belt 43. The two saw wheels 41 are arranged in the direction of the Z axis of the base 10 that they are vertically separated (as shown in FIG. 1 and FIG. 2). The saw belt 43 is wound around the two saw wheels 41 as a loop. The power source 42 outputs power to drive the two saw wheels 41 to rotate, and the rotation of two saw wheels 41 further drives the saw belt 43 to circle. The feeding device 30 pushes the food object 1 toward the saw belt 43, and the trolley 20 performs to-and-fro movement with respect to the X axis of the base 10. Thereby, the saw belt 43 cuts the food object 1 (as shown in FIG. 6 and FIG. 7).

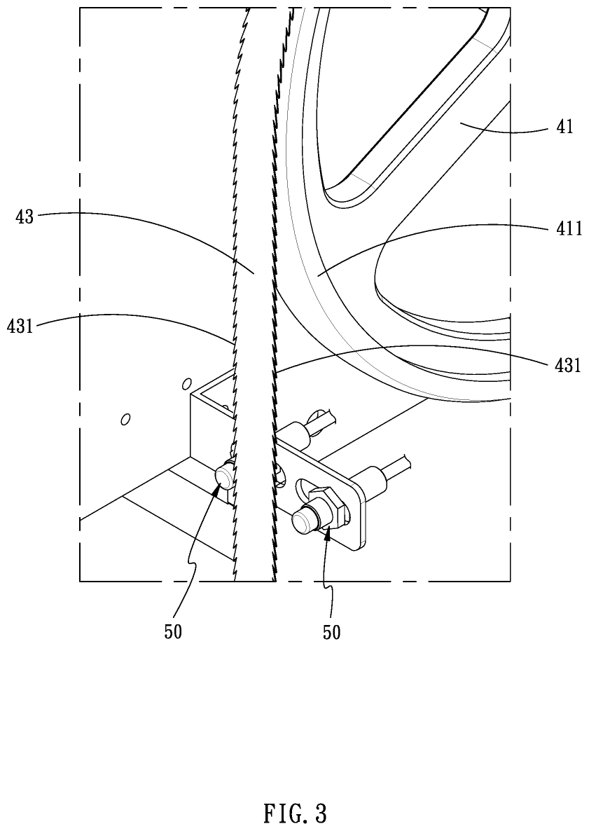

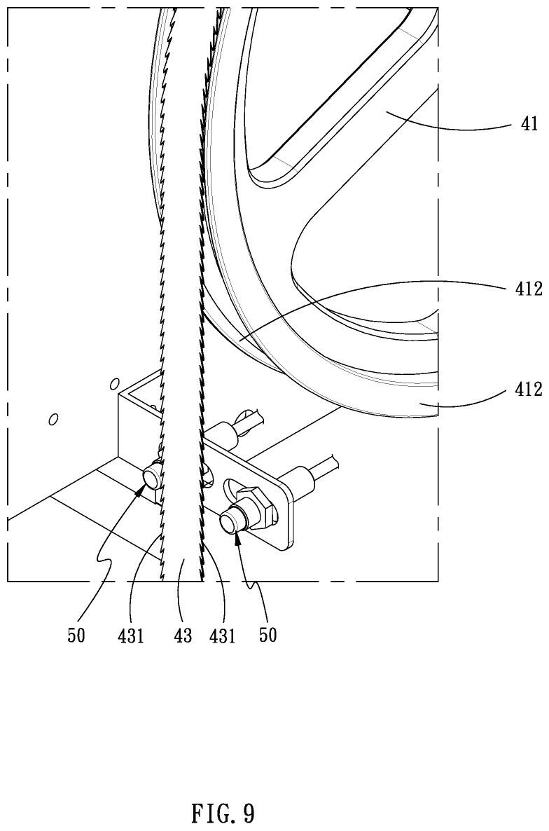

Referring to FIG. 1, FIG. 3, and FIG. 9, teeth 431 are provided on the two opposite, lateral edges of the saw belt 43. Both of the teeth 431 at the two edges of the saw belt 43 can cut the food object 1, thereby effectively enhancing the cutting efficiency of the disclosed apparatus.

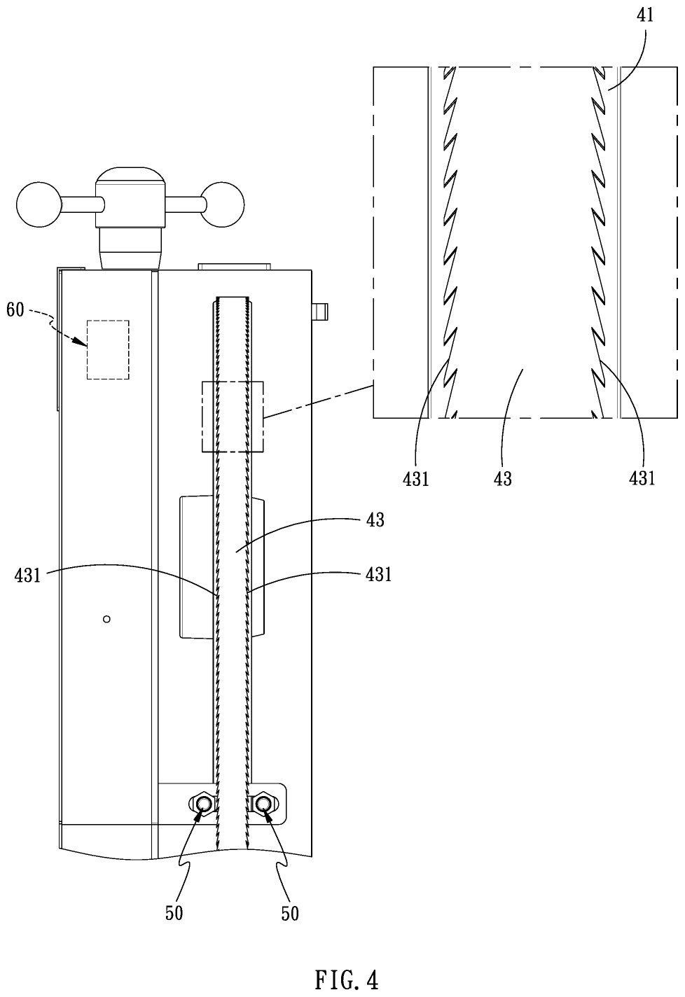

In the embodiment of the present invention, as shown in FIG. 3 and FIG. 4, each of the saw wheels 41 has chamfered parts 411 formed along its two rim edges, and the chamfered parts 411 form salients on the rim so as to hold the saw belt 43 in position and prevent the saw wheels 41 from wearing the teeth 431 of the saw belt 43.

In another embodiment of the present invention, as shown in FIG. 9, each of the saw wheels 41 has flanges 412 formed along its two rim edges. The saw belt 43 is positioned and retained between the two flanges 412 of each of the saw wheels 41.

The detector 50 is located beside the saw belt 43. In the embodiment of the present invention, there are two detectors 50 arranged separately to correspond to the teeth 431 on the two edges of the saw belt 43, respectively, as shown in FIG. 3 and FIG. 4.

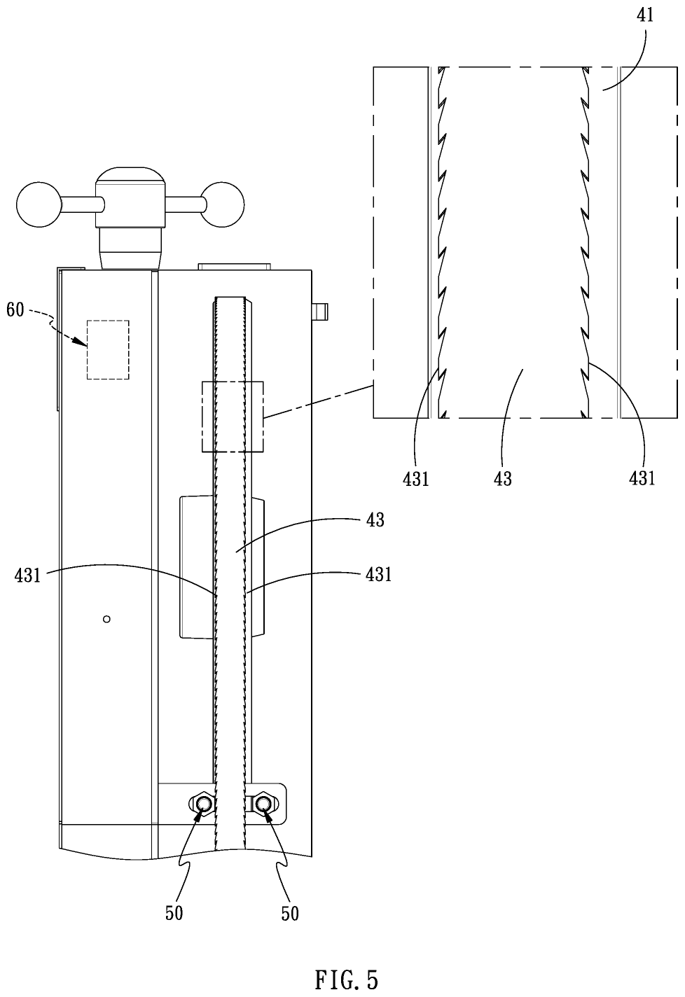

The detectors 50 serve to monitor intactness of the teeth 431 of the saw belt 43. When the saw belt 43 is intact, it remains at the middle of the rim of each of the saw wheels 41, as shown in FIG. 4. When the saw belt 43 is worn and therefore becomes deflective, it moves toward either of the detectors 50. Once the saw belt 43 enters the detection range of the detector 50 and is detected by the detector 50, the detector 50 determines that the teeth 431 is worn and generates a warning signal, as shown in FIG. 5. Therein, the detectors 50 may be non-contact sensors. In the embodiment of the present invention, the detectors 50 are proximity switches.

It is to be noted that in another embodiment of the present invention, when the detector 50 fails, the two flanges 412 of each of the two saw wheels 41 can protect the saw belt 43 as an additional insurance, thereby better protecting the saw belt 43.

The controlling device 60 is coupled to the trolley 20, the power source 42 of the cutting device 40, and the detector 50. The controlling device 60 is configured to receive the warning signal generated by the detector 50, accordingly control the power source 42 and slow down the movement of the trolley 20.

Specifically, when the controlling device 60 cuts off the power source 42 in response to the warning signal, the to-and-fro movement of the trolley 20 with respect to the X axis of the base 10 is decelerated. If the controlling device 60 does not receive the warning signal anymore after the deceleration of the trolley 20, it means that the saw belt 43 is still usable. If the controlling device 60 remains receiving the warning signal after the deceleration of the trolley 20, it means that the saw belt 43 has been worn seriously and needs to be replaced.

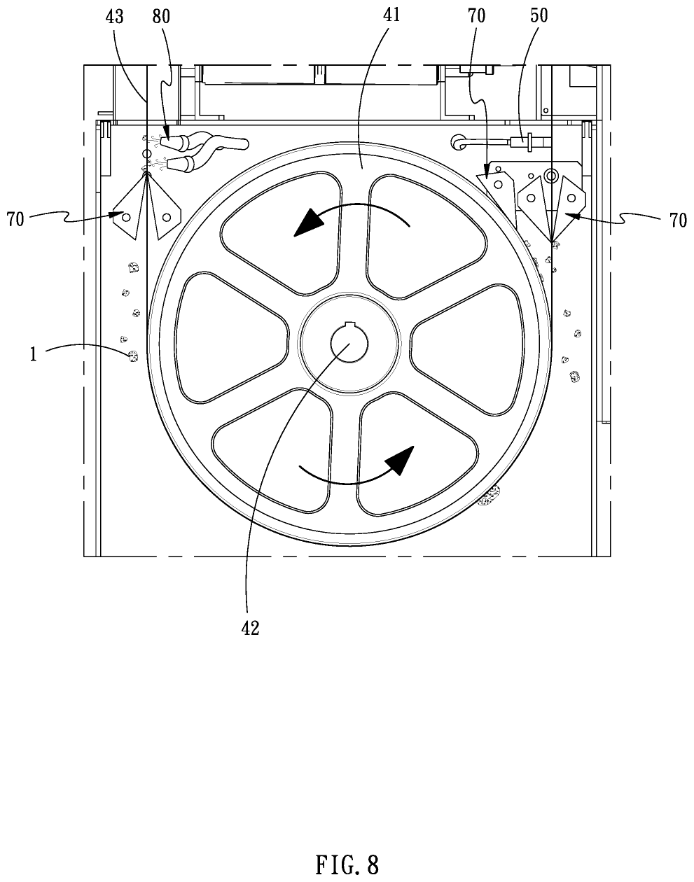

In another embodiment of the present invention, the detector 50 may be located at the inner side of the saw belt 43 (as shown in FIG. 8), and the detector 50 may be capable of generating a warning signal when detecting any fracture on the saw belt 43, so that the controlling device 60, in response to the warning signal, can cut off the power source 42 for replacement of the saw belt 43 and resume the operation of the apparatus when an intact saw belt 43 is properly installed.

The plurality of guide blocks 70 are arranged correspondingly beside the two saw wheels 41 and the saw belt 43 for removing residue of the cut food object 1 from the two saw wheels 41 and the saw belt 43 as they are rotating. Therein, each of the guide blocks 70 is a triangular block or a trapezoid block and has a tip pointed to the saw wheels 41 or the saw belt 43, as shown in FIG. 2, FIG. 7, and FIG. 8.

The plurality of blast guns 80 are located correspondingly beside the saw belt 43 and close to one of the saw wheels 41. In the embodiment of the present invention, there are two blast guns 80, both at the same side of the lower saw wheel 41. Therein, the blast guns 80 spurt gas to blow off residue of the cut food object 1 from the saw belt 43, as shown in FIG. 2, FIG. 7, and FIG. 8.

To sum up, the present invention has the following beneficial effects.

First, with the detector 50, the disclosed apparatus is capable of monitoring intactness of the teeth 431 on the saw belt 43 and timely stopping or slowing down the movement of the trolley 20 when being aware that the saw belt 43 is worn, thereby enabling an operator to replace the saw belt 43 and maintaining the processing quality.

Furthermore, with the single saw belt 43 having teeth 431 at its two opposite, lateral edges, the disclosed apparatus is capable of cutting in two directions, thereby effectively improving food processing efficiency.

In addition, with the guide blocks 70 and the blast guns 80, the disclosed apparatus is capable of effectively removing food residues from the saw wheels 41 and the saw belt 43, thereby keeping the cutting device 40 clean.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A food-cutting apparatus for cutting a food object, the food-cutting apparatus being characterized in:
a base;
a trolley, which is movably mounted on the base for the food object to place thereon;
a cutting device, which is mounted on the base and has two saw wheels, a power source, and a saw belt, the two saw wheels being vertically separated with respect to the base, the saw belt being wound around the two saw wheels as a loop, the power source driving the two saw wheels to rotate and further driving the saw belt to circle, and the trolley driving the food object so that the food object is cut by the saw belt, wherein teeth are provided on the two opposite, lateral edges of the saw belt;
a detector, which is located beside the saw belt and serves to monitor intactness of the teeth of the saw belt and generate a warning signal when determining that any of the teeth is worn; and
a controlling device, which is coupled to the trolley, the power source of the cutting device, and the detector, and serves to cut off the power source and slow down movement of the trolley when receiving the warning signal generated by the detector.

2. The food-cutting apparatus of claim 1, being characterized in further comprising a plurality of guide blocks, arranged correspondingly beside the two saw wheels and the saw belt, so that when the two saw wheels rotate and the saw belt circles, the guide blocks remove residues of the food object from the two saw wheels and the saw belt.

3. The food-cutting apparatus of claim 2, being characterized in that each of the guide blocks is roughly a triangular block or a trapezoid block that has a tip pointed toward the corresponding saw wheels or the saw belt.

4. The food-cutting apparatus of claim 1, being characterized in further comprising a plurality of blast guns, located beside the saw belt and close to one of the saw wheels for spurting gas to blow off the residues of the food object from the saw belt.

5. The food-cutting apparatus of claim 1, being characterized in that the detector includes two detectors, arranged separately to correspond to the teeth on the two edges of the saw belt, respectively.

6. The food-cutting apparatus of claim 5, being characterized in that the detectors are non-contact sensors.

7. The food-cutting apparatus of claim 6, being characterized in that the detectors are proximity switches.

8. The food-cutting apparatus of claim 1, being characterized in that each of the saw wheels has chamfered parts formed along its two rim edges and the saw belt is positioned between the two chamfered parts of each of the two saw wheels.

9. The food-cutting apparatus of claim 1, being characterized in that each of the saw wheels has flanges formed along its two rim edges, and the saw belt is positioned between the two flanges of each of the saw wheels.

10. The food-cutting apparatus of claim 1, being characterized in that a feeding device is movably mounted on the trolley and serves to push the food object toward the saw belt.
